(19) United States
(12) Patent Application Publication
(10) Pub. No.: US 2011/0073715 A1
(43) Pub. Date: Mar. 31, 2011

(54) Method and apparatus for generating propellantless propulsion

(76) Inventor: Neville Macaulife, Oak View, CA (US)

(21) Appl. No.: 12/586,661

(22) Filed: Sep. 25, 2009

(51) Int. Cl. B64G 1/40

(52) U.S. Cl. 244/171.5

(57) ABSTRACT

Existing spacecraft accelerate by ejecting propellant, and VTOL craft hover by creating violent downdrafts of air. We describe a propellantless propulsion system that can achieve practical spaceflight and hovering flight by exchanging momentum with normally unobservable quantum particles that pervade all of space.

High-polarizability nanoparticles with electromagnetic resonances in the petahertz range are formed into nanoantennas, and exposed to high fields in the terahertz range. The fields increase the density of naturally occurring vacuum fluctuation (VF) petahertz oscillations in the nanoantennas. The nanoantennas are assembled into arrays, such that their naturally occurring zero-point oscillations are amplified by the terahertz fields, producing enhanced oscillations in VF densities during each petahertz oscillation period that interfere constructively in the intended direction of emission. This causes the VF oscillations to partially convert to travelling waves that emit from the system, creating an imbalance in VF pressure and urging the device to move in the direction of least pressure.

### CROSS-REFERENCE TO RELATED APPLICATIONS

Not Applicable

### FEDERALLY SPONSORED RESEARCH

Not Applicable

### SEQUENCE LISTING OR PROGRAM

Not Applicable

### BACKGROUND OF THE INVENTION

Apparatus is described for achieving propellantless propulsion of space and air vehicles, by causing the naturally occurring radiation pressure (RP) of virtual quantum particles to become greater on one side of the claimed device than the opposite side, thus causing movement in the direction of least pressure. The apparatus may also provide hovering flight of airborne vehicles without requiring violent downdrafts of air, or exert force on various objects as may be useful for industrial processes or meet other needs.

### BRIEF SUMMARY OF THE INVENTION

Hitherto, space vehicles have been propelled by the ejection of propellant; and aircraft, by thrusting against air. The application presents viable alternatives whereby such vehicles may achieve motion by absorbing from free space, amplifying, and re-emitting unidirectionally, the virtual radiation of so-called virtual particles such as vacuum fluctuations (VFs). The claimed means of doing so are as follows:

1. Electromagnetic oscillators generate above zero-point VF densities in high-polarizability nanoparticles such as buckyballs or other fullerenes. The nanoparticles being formed into nanoantennas, either singly, or in combination, by, for example, joining about twelve C3840 buckyballs to form full-wave linear petahertz nanoantennas.
2. A numerically large number of such nanoantennas are formed into 2D arrays, which are then stacked to form 3D arrays.
3. The nanoantennas are so spaced apart as to oscillate in a phase relationship such that they interfere constructively in a given direction here termed the forward direction, and destructively to the rear and sides.
4. This transforms the forward-directed VF oscillations from standing waves to travelling waves, which then move or shunt along the nanoantennas, combining their amplitudes as they do so, until they emit from the final tier of nanoantennas.
5. The VF flow creates a below zero-point VF pressure in the rearward nanoantennas, causing a replenishing flow of VF waves to be drawn into the device from the rearward free space surroundings, thus allowing the forward flow of VFs through the device to continue for as long as the device is appropriately energized.
6. The device thus produces thrust via the generation of radiation pressure somewhat analogously to a photon rocket. However, photons require hv joules to create them, but only supply hv/c newtons of radiation pressure, where h is Planck's constant, v the photon frequency, and c the speed of light in free space. This means that the thrust to power ratio is an abysmal 1/c newtons per joule at best. It is hard to imagine anything less efficient, for even moving a single skateboard would require the entire output of numerous power stations to be converted into photons! By contrast, VFs are freely provided by nature, and, in principle, require no unrecoverable energy to create them except in so far as their creation generates pressure. It follows that the propulsive efficiency of a VF radiating device can, in principle, approach a limit of one newton of thrust per joule.

We wish to point out that while we have described VFs as travelling through space much as do photons, we consider this to be only a mental image, since the behavior of VFs in free space is an unobservable; it being only their interactions with matter that are capable of direct detection and measurement.

What is known, and what is claimed here as an operating principle of the invention, is that VFs possess a momentum of ½hv/c, and their unidirectional emission from the forward antennas in the claimed device must create a reactive force acting on the device, urging it rearward.

It will be shown that the claimed device permits electrical equipment oscillating in, for example, the terahertz frequency range, to generate VF emissions in the petahertz range.

### BRIEF DESCRIPTION OF THE DRAWINGS

FIG. 1A shows twelve high-polarizability buckyballs combined to form a nanoantenna.

FIG. 1B shows in side view, sixty-four FIG. 1A nanoantennas formed into a 3D array or stack, comprising eight vertical columns, each with eight horizontal tiers.

FIG. 1C shows the stack of FIG. 1B in front view.

FIG. 1D shows a stack in side-view, in which the nanoantennas are randomly spaced.

FIG. 1E shows antennas formed from buckyballs in two 8×8 tiers.

FIG. 1F shows an 8×8 matrix of nanoantennas constructed from buckyballs, mounted on a substrate to form long-wire antennas.

FIG. 2 shows eight stacks as FIGS. 1B & 1C combined together to form a “thrust generator,” by which is meant an assemblage of stacks so assembled, constructed, and energized by electromagnetic devices, as to emit VF radiation unidirectionally.

FIG. 3 shows schematically how a motor may be constructed by mounting suitably modified FIG. 2 thrust generators around a rotatable shaft, such that their radiative outputs are directed tangentially to the shaft.

FIG. 4 Shows FIG. 2 thrust generators powered by an electromagnetic terahertz frequency generator.

FIG. 5 shows an electromagnetic generator output waveform, and the waveforms it generates in two nanoantennas that are oscillating in a particular phase relationship with each other.

FIG. 6 shows typical polar field diagrams for two antennas separated by a given number of wavelengths. The larger diagram sums their combined output.

### REFERENCES

### (a) Background References

1. Milonni, Peter W, The Quantum Vacuum, an Introduction to Quantum Electrodynamics, Academic, 1994.
2. Milonni, P W, Cook, R J; Goggin, M E; Radiation Pressure from the Vacuum: Physical Interpretation of the Casimir Force, Phys. Rev., A38, p1621, 1988.
3. Bohm, David, Quantum Theory, 1951, p415; Dover reprint, 1989.
4. Bonin, Keith D & Kresin, Vitaly V; Electric-Dipole Polarizabilities of Atoms, Molecules and Clusters, World Scientific, 1997.
5. Sopova, V; Ford, L H; Casimir Force between a Small Dielectric Sphere and a Dielectric Wall, arXiv:quant-ph/0406021 v1 1 Jun. 2004.
6. Gueorguiev, G. K; Pacheco, J M; and Tomanek, David; Quantum-Size Effects in the polarizability of Carbon tubules, Physical Review Letters, 92, p215501-1 to 4, 2004.
7. Casimir, H B G; Polder, D; The Influence of Retardation on the London-Van der Waals Forces, Phys. Rev., 73, p360-372, 1948.
8. Power, E A; Introductory Quantum Electrodynamics, American Elsevier, 1965.
9. Ford, L H; Svaiter, N V; Amplification of Vacuum Fluctuations, http://www.physics.umd.edu/rgroups/ep/yskim/boston/ford.pdf.
10. Levin, Frank S; Micha, David A; Long-Range Casimir Forces, Theory and Recent Experiments on Atomic Systems; Plenum, 1993.
11. Power, p136.
12. Milonni, p49.
13. Lide, David R, Ed., Handbook of Chemistry and Physics, 85th edition, CRC Press, 2004-2005; 10-167-182, 12-17-18.
14. Milonni, p2.
15. Amusia, M Ya et al, Dramatic distortion of the 4d giant resonance by the C60 fullerene shell. J. Phys. B: At. Mol. Opt. Phys. 38, 2005, p L169-L173.
16. Farson, D F; Choi, H W; & Rokhlin, S I; Electric discharges between platinum nanoprobe tips and gold films at nanometre gap lengths;* Nanotechnology 16 (2005) p1-8.
17. Patten, Van P G; Noll, J D; Myrick, M L; Spark-gap atomic emission spectroscopy 2. Improvements in resolution; J. Vac. Sci. Technol. B 15(2), March/April 1997.
18. Kraus & Markefka, p830-835, and p848-850.
19. Karalis, Aristeidis; Joannopoulos, J. D; Soljacic, Marin; Efficient wireless non-radiative mid-range energy transfer. 19 pages. arxiv.org/pdf/physics/0611063v2. Also, for material on evanescent transmission see: Brady, J. J, Brick, R. 0, Pearson, M. D; Penetration of Microwaves into Rare Medium in Total Reflection. Journal Optical Society of America, 50, p1080-1084, 1960. And: Raad, Bechara A; Jacobs, Ira; Tunneling Through a Total Internal Reflection Layer, IEEE Transactions of Education, 35, p112-114, 1992.
20. Kraus, John D & Marhefka, Ronald J; Antennas for All Applications; Third Edition, Tata McGraw-Hill, 2003.
21. Corso, Martina et al; Boron Nitride Nanomesh, Science, 303, p217, 9^{th} Jan., 2004.
22. Kaganovskii, Yu S et al; Langmuir-Blodgett films of the fullerene C60; JETP Lett., 60, No. 5, Sep. 10^{th}, 370-374, 1994.
23. Hecht, David, S, et al; Electronic properties of carbon nanotubes/fabric composites; Current Applied Physics, xxx (2005) xxx-xxx. Online at www.sciencedirect.com.
24. Maroulis, George; Atoms, Molecules and Clusters in Electric Fields, Imperial College Press, 2006.
25. Casimir, H. B. G; Proc. K. Ned. Akad. Wet.; 51, p793, 1948.
26. Hushwater, V; Radiation approach to the repulsive Casimir force; arXiv:quant-ph/9909084v1, September, 1999.
27. Bertsch, George F et al; Collective Plasmon Excitations in C60 Clusters; Physical Review Letters, 67, No. 19, 4 November, 1991; available online.
28. Wikipedia online encyclopedia; Terahertz radiation.
29. Ozyuzer, L et al; Emission of Coherent THz Radiation from Superconductors; Science, 318, 23 November, 2007; 1291-1293; available online.
30. Bower, Chris et al; A Micromachined Vacuum Triode Using a Carbon Nanotube Cold Cathode; IEEE Transactions on Electron Devices; 49, No. 8, August, 2002; p1478-1483; available online.
31. Zhu, Jinfeng et al; Simulation of Field Emission Micro-Triode Based on Coaxial Nanostructure; J Infrared Milli Terahertz Waves (2009) 30:94-102; available online.
32. Wang, C. P. Michael and Gates, D. Byron; Directed assembly of nanowires; Materials Today, May, 2009; p34-43.
33 Barlow, H. E. M; Bending waveguides—breakthrough in communications; Discovery, August, 1965.
34 Scmitt, Ron; Understanding electromagnetic fields and antenna radiation takes (almost) no math; ww.ednmag.com. Milonni, p220.
36 Kraus & Markefka; 0548.

### (b) General Review References

Bonin, Keith D & Kresin, Vitaly V; Electric-Dipole Polarizabilities of Atoms, Molecules and Clusters, World Scientific, 1997.
Kraus, John D & Marhefka, Ronald J; Antennas for All Applications; Third Edition, Tata McGraw-Hill, 2003.
Levin, Frank S; Micha, David A; Long-Range Casimir Forces, Theory and Recent Experiments on Atomic Systems; Plenum, 1993.
Maroulis, George; Atoms, Molecules and Clusters in Electric Fields, Imperial College Press, 2006.
Milonni, Peter W, The Quantum Vacuum, an Introduction to Quantum Electrodynamics, Academic, 1994.

### Special Terms Used

Tier: A 2D nanoantenna array.
Stack: A 3D nanoantenna array.
Thrust generator or TG: A device in which a number of stacks are assembled such that they combine their radiative outputs.
VFs: Vacuum fluctuations.
Forward direction: The direction in which the radiative output of the stacks combines constructively. Opposite: Rearward direction, associated with destructive interference, or redirection of output.

### DETAILED DESCRIPTION OF THE INVENTION

### Introduction

It is well established that quantum entities known as vacuum fluctuations (VFs), pervade all of free space at a mean energy density known as the zero-point. The VFs are, in fact, virtual photons, the word virtual denoting that their transitions do not conserve energy, and thus render their energy inaccessible [1]. This assumption of inaccessibility is being challenged by some ingenious proposals, however, what concerns us here is the known fact that VFs possess momentum which is constantly traded back-and-forth with real-world particles [1, 2, 5, 8-10, 12, 26]. This indicates that one-waying VFs in guiding structures may produce unidirectional propulsive effects.

It may seem unphysical to suggest that VF momentum can be accessible while VF energy is not. However, while the energy is held to be inaccessible because the vacuum has no lower state the VFs can fall into (i.e, there can be no change of state), linear momentum is equivalent to a harmonic oscillation of zero hertz and is not comparably restricted.

One might also note that the term virtual does not mean unreal! In fact, so-called virtual transitions have very real effects. To name but one example, the Van der Waals attractions between molecules—the very glue that holds our entire world together—arises from virtual transitions [3].

We require no weird physics to explain the operating principles of the claimed devices. We first consider the known fact that the relationship for the interaction of an induced dipole with an electric field is provided by E_{α}=(−½αE²), where

E_{α} is the potential energy in joules, E is the electrical field strength in volts per meter, and α the electrical polarizability of the dipole in Cm²/V [1, 4, 5, 9-11]. The units are SI, and may be applicable to both to static and dynamic polarizabilities [5]. The minus sign (discarded from here on), indicates the resulting force is attractive.

What is particularly relevant for our purposes is that this term provides the potential energy that appears between a polarizable particle and a conductive wall due to the action of VFs alone [1, 7-11]. It can also produce the force between two polarizable particles that is likewise due to VFs, as will be developed below.

These matters suggested to the applicant that if giant-polarizability nanoparticles were formed into 3D nanoantenna arrays, and their E_{α} energy components cycled up and down by externally applied fields, this might produce rapid oscillations of their associated VF field densities, causing the nanoantennas to emit VFs unidirectionally, in rather the same way that conventional antenna arrays [20] emit radar and signal-carrying beams when driven in phase-quadrature.

Before proceeding with practical details, we address the following theoretical concerns.

### The Reality of Vacuum Fluctuation Pressure and Momentum Exchange.

It is a known fact that VFs possess a momentum of ½hv/c newton per fluctuation that can exert pressure on real-world particles [1, 2, 10, 14, 15, 25, 26]. Further, VFs are widely believed to exist independently of matter [1, 2, 9, 11, 12, 26], and thus exert a pressure on any object reflecting a VF field. This pressure equals 2u for incident radiation reflected from a plane surface on one side, where u is the free-space or zero-point energy density. The pressure reduces to u if the radiation is evenly divided between both sides of the reflector, and equals u/3 for an isotropic distribution, in which case both sides are referred to by definition [2, 12, 14].

It follows that if any means is found to create a greater VF pressure one side of an object than the other, the object will be urged to move in the direction of least pressure. This is the simple principle underlying the proposed propulsive apparatus.

Some analysts have a reluctance to accept—despite the overwhelming number of papers that now routinely define vacuum quantum electrodynamics in terms of vacuum fluctuation theory—that fluctuating vacuum fields exist in the absence of physical sources. However, Peter Milonni, while discussing laser linewidths in his definitive book The Quantum Vacuum [1], refers to “the external vacuum field” transmitting through a laser mirror, undergoing amplification as it propagates to the second mirror, and then being reflected (p194). He then writes:
“It is worth noting again that our calculation of the Schawlow-Townes linewidth assumes that the vacuum field is transmitted, reflected, and amplified in the same way as fields of “real” photons, i.e., fields defined in terms of excited states of the field. The transmission and reflection properties of the vacuum field are consistent with the fact (see {P.M's} Sections 2.4 and 6.2) that the spatial variations of the quantized field are the same as those of the classical field subject to the same boundary conditions. The fact that the vacuum field may be amplified follows from the fact that its contribution to the laser linewidth is more or less interchangeable with the contribution from spontaneous emission: If spontaneously emitted radiation inside the cavity is amplified by the gain medium, then so too must the vacuum field entering the cavity.” (p197-198.)

It may be particularly noted, that Milonni describes the VFs as being amplified, reflected, and transmitted without undergoing any conversion into real photons. This directly contravenes the expectations of some pundits that VFs transmitting from such apparatus would so convert into photons.

Another commonly raised objection to the idea that VFs possess radiation pressure independently of matter, is that the Casimir effect can be negative.

For those unfamiliar with the subject matter, we explain that the Casimir effect or force is most typically demonstrated when two metal plates are separated from each other by a submicron distance. When this is done, a small attractive force is observed, the reason being, generally speaking, is that there are less VF modes between the plates urging them apart, than there are VF modes outside the plates urging them together. Thus the latter VF modes produce the greater radiation pressure, resulting in a net inward force.

However, there are a number of geometries and configurations in which the pressure in small gaps exceeds the external pressure. This has led to the dubious argument that the pressure is a special case of the van der Waals molecular forces. But lately Hushwater [27], has demonstrated that, in such cases, the negative pressure is due to there being a greater number of VF modes within the gap than without.

Lifshitz has also shown, in a seminal paper, that intermolecular forces may cease to be additive when the dielectric constants are high [35].

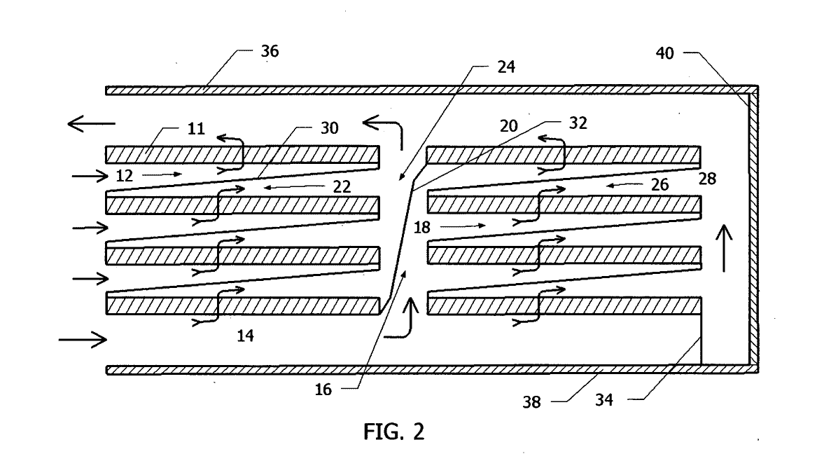

We therefore claim the VFs will exert pressure on the claimed devices. By way of example, we look ahead to the device shown in FIG. 2. It is not necessary to understand how it works at this time, but merely accept that the arrows show the flow of VFs through the apparatus; and that the apparatus will amplify or pressurize the VFs when appropriately energized. We assume isotropic VF distributions, and consider only horizontal pressures since all others will balance out. We determine the forces acting on the device as follows:

(1). If VFs enter the device from the left as shown, pass through the stacks as 10, and exit back to the left without amplification or loss, they will produce a pressure of u/3 newton per square meter urging the device to the right. This pressure will, of course, equal the zero-point pressure of free space.

(2). Some VFs that would otherwise enter the device are scattered back by the left-facing edges of cover plates 42 & 38, the four leftmost stacks as 10, and the stub-like leftmost vertical sections of the three leftmost partitions as 30. These scatterings will exert an ambient pressure of u/3 N/m² urging the device to the right.

(3). VFs approaching from the right, and encountering the right-hand cover plate 40 will exert the same pressure of u/3 urging the device to the left.

(4). The above pressures clearly sum to zero because the left-hand and right-hand areas are identical. Thus, the net pressure=(1)+(2)−(3)=0.

(5). However, if the VFs entering the device as (1) are amplified by their passage through the stacks as 10, their pressure will clearly rise above ambient or zero-point levels. For example, if pressure (1) is doubled by amplification, the resultant net pressure will be approximately 2×(1)+(2)−(3)=(1)≅u/3 N/m², urging the device to the right. The “nearly equals” is inserted because the emitted distribution will no longer be isotropic.

### A Small Sample of Relevant Patents Issued by the US Patent Office

The US Patent Office has granted a number of patents to inventors attempting to harness VFs or zero-point energy to create new energy sources and the like. The applicant does not consider any to anticipate his own claims, but offers the following as a small sample.

1. In 1996 Dr. Frank Meade was granted U.S. Pat. No. 5,590,031 which claimed two spherical antennas resonating passively at different frequencies, that gathered VF radiation from free space, thereby generating a VF radiation beat-frequency to be supplied to electrical devices and perform work. Thus the USPO recognized the possibility that VF radiation exists freely in space and that it may be harnessed for useful purposes, even if there is an appearance of building a “free energy” device. A matter that does not concern us in the present application.
2. In 1987 Federico Capasso was granted U.S. Pat. No. 4,704,622 which claimed devices that could harness VFs to enhance the tunneling abilities of electrons in solid-state devices utilizing quantum wells. Although the present application makes no claims involving VFs in such electronic devices, which operate by electron-hole formations, such a VF aid to tunneling is similar in principle to the present inventor's claim that VFs can shift progressively along chained nanoantennas, especially those that lie within each others near-fields.
3. In 1977 Grigg was granted U.S. Pat. No. 4,004,210 for devices that utilized zpe pressure to drive fluctuations through electronic devices in a cold to hot direction. He insisted for many years that such a thing need not violate the second law, and he may have gained some support, since a multi-national company is reported to have a “nanorectifier” program which at least sniffs at such feasibilities. Again, the US Patent Office has recognized the possibility that VF radiation pressure may perform work, and we note that accepting that VF pressure may drive energy from cold to hot is a far greater leap than to accept that appropriate devices can simply transform VF oscillations from standing waves to travelling waves and emit from the claimed apparatus. However, it is to be understood that the present inventor makes no claim for any device that violates physical law.
4. In 2002 F. Pinto was granted U.S. Pat. No. 6,477,028 which claimed apparatus for storing “Casimir force energy” (i.e, VF radiation) by, in one case, linking two “Casimir force generating boundaries” while varying the physical parameter of the environment separating them. This is another example of the US Patent Office accepting the possibility that VF radiation can be treated as a working medium for producing useful effects.

### Giant Polarizability

Returning to the earlier discussion regarding the construction of nanoantennas using materials possessing large electrical polarizabilities, we find that carbon fullerenes such as buckyballs [6], and materials such as Na₁₄F₁₃ possess so-called giant polarizabilities that can be some three orders of magnitude greater than the run of the mill values customarily found in handbooks [13]. We note particularly that Gueorguiev et al [6], have calculated that a 3840-atom buckyball has what they term an α_{LCAO} figure (based on calculations involving linear combinations of atomic orbitals), of 33,731 Å³, or 3.75×10⁻³⁶ Cm²/V in the SI system. Therefore, by way of example, we consider the use of these buckyballs to construct the nanoantennas.

The Antenna Stacks and their Construction

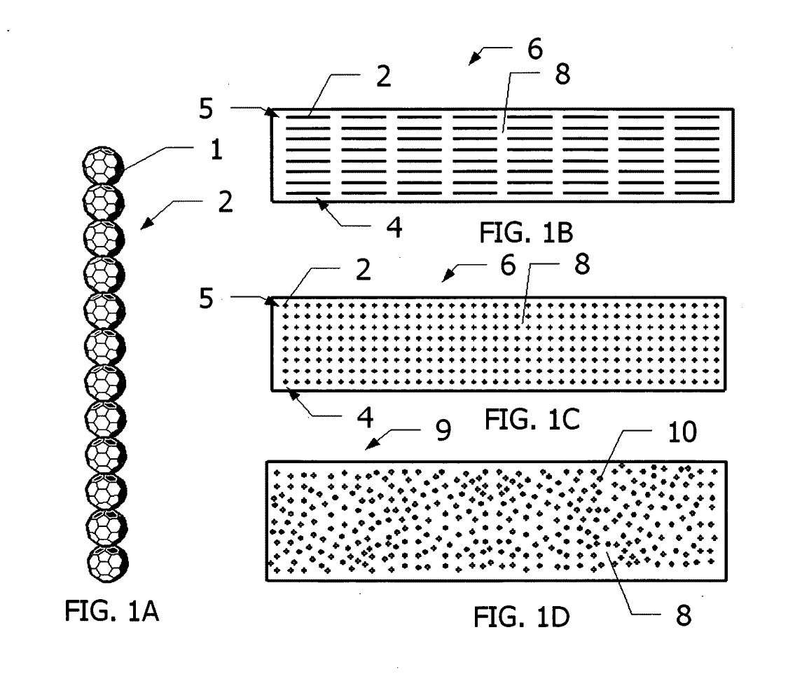

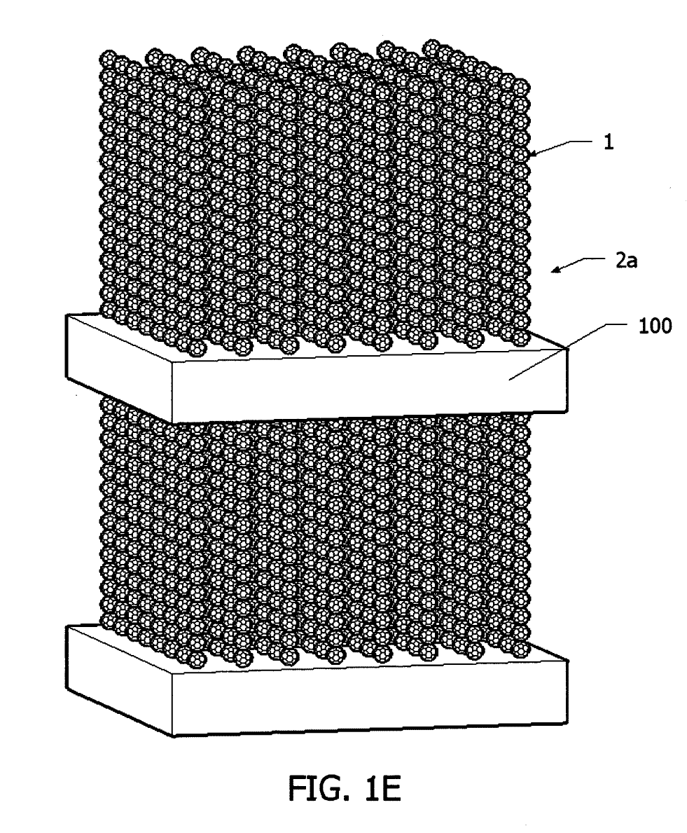

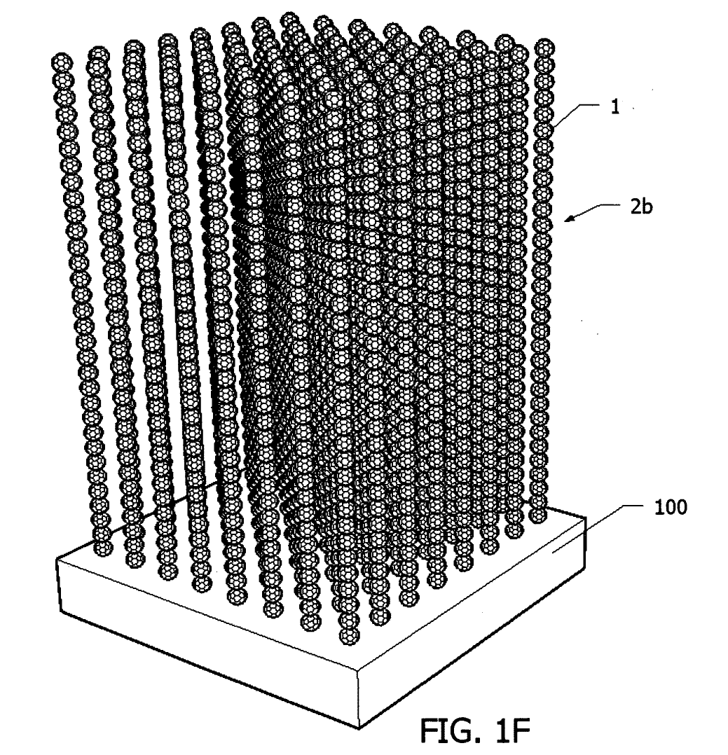

FIG. 1A shows twelve buckyballs as 1 mounted together to construct a linear nanoantenna 2. FIG. 1B shows, in front view, sixty-four such nanoantennas as 2 formed into eight columns as 4, each with eight horizontal (2D) tiers as 5, to create a 3D nanoantenna array or stack 6. The antennas are embedded in a dielectric or aerogel substance 8.

FIG. 1C shows stack 6 in side view, revealing forty of the previous eight-tier columns as 4. It is envisaged that such stacks might consist of about 26 tiers as 5 each consisting of ˜10¹⁶ antennas per square meter, all emitting broadside in the preferred case (i.e, vertically in FIGS. 1B & 1C), and embedded in a dielectric or aerogel substance 8.

FIG. 1D shows a stack 9 in which can be seen about sixty spherical nanoantennas as 10 spaced randomly, and embedded in a dielectric or aerogel substance 8. It will be described later.

FIG. 1E shows 128 antennas as 2a formed from buckyballs as 1, in two 8×8 tiers which may be stacked—as many as required—between substrates as 100, two of which are shown. An advantage of such an assembly is that there is no requirement to embed the antennas in a dielectric. Such nano-structures can be caused to self-assemble, as is explained below.

FIG. 1F shows an 8×8 matrix of nanoantennas as 2b, formed from buckyballs as 1, mounted on substrate 100, in extended lengths that may act operatively as what are known to those versed in the arts, as long-wire antennas. Thinner versions of substrate 100 may be used to brace longer antennas at regular intervals.

Buckyballs may be readily formed into a well-ordered 2D array by attaching them to a nanomesh. One such suitable nanomesh consists of a single layer of boron nitride, another is graphene. A boron nitride mesh can be formed by self-assembly if an operator exposes a rhodium or ruthenium surface to borazene at high temperatures in an ultra-high vacuum [21]. Such nanomeshes have a remarkable ability to trap fullerenes, and also other particles such as molecules, nanoparticles, and metallic clusters, in their pore matrix, such that each pore seats one buckyball.

A nanomesh described in the above reference had a periodicity of 3 nanometers, and a 2 nanometer hole diameter. However, similar nanomeshes can now be tailored to meet a wide range of geometric, and also electrical specifications, such as whether conductive or insulating parameters are required.

A second method by which an operator may build a 2D buckyball array on a nanomesh is by spraying [23]. For example, purified arc buckyballs such as may be purchased from Carbon Solutions, California, USA, can be added to an aqueous solution of 1% sodium dodecyl sulfate (SDS), at a concentration of 0.02 to 0.05 mg buckyballs per ml of solution. The resulting suspension is mixed by sonication for one hour, and then sprayed onto the nanomesh in a fine mist by means of a Paasche airbrush. It is necessary to heat the nanomesh to 100 degrees centigrade to prevent the formation of large droplets. It is then soaked in water to remove residual SDS.

An operator may also produce 2D buckyball arrays by dissolving the buckyballs in benzene, and depositing them on the surface of doubly-distilled water [22]. The solvent is allowed to evaporate, leaving behind a self-assembled film of buckyballs. The film is then compressed by a barrier that is moved at microscopic speed, applying a pressure of about 0.02 N/m to the film as it does so. The film can then be transferred to a substrate using the Schaefer method, in which the film is moved horizontally by contact with a hydrophobic plate.

It will be apparent that such 2D buckyball arrays may be readily mounted one above another to form the stacks required for the present application. This requires that the spacing between each 2D array be such as may best develop the electrical phase relationships to be described later. This may be accomplished by using much the same airbrush spraying technique as revealed above to coat the buckyball arrays with a dilute solution cadmium telluride, using such amount as will produce a dielectric film of the desired thickness once the solvent has evaporated. A second 2D buckyball array may then be placed on the film, and the above operations repeated until the desired number of tiers has been formed.

Although FIG. 1A shows the use of only a single column of buckyballs to construct an antenna, it will be understood that multiple parallel columns may be used to provide a thicker antenna, thereby, for example, increasing the bandwidth. Alternately, multiple buckyballs or other fullerenes might be used singly, or clustered to form spherical antennas. Thereby, for example, abolishing any need for the axial alignment that non-spherical antennas may require. Such particles may also operate as point-source antennas.

Buckyballs link together naturally to form chains as FIG. 1A when formed into a suspension in suitable solvents. Droplets of such a suspension may then be formed onto a substrate, subjected to DNA hybridization, and finally immobilized with random orientations either on or between Au electrodes. The nano-chains may then be straightened naturally by the shear-forces generated by an evaporating droplet [32].

Alternately, the substrate may be etched with linear cavities of suitable length and width to trap buckyballs and form them into antennas as FIG. 1A. The cavities being spaced apart lengthwise and sidewise as necessary to form tiers as 5 FIG. 1B & 1C. The substrate may then be rinsed clean of all other fullerene material. At which time a similar substrate may be mounted atop it, and such stacking of substrates continued until a 3D stack of suitable tier count has been assembled, as described above.

### The Thrust Generator

FIG. 2 shows in schematic, seriously not to scale side-view, the mid-cross-section of a device we term a thrust generator (TG). The figure shows eight stacks as 11. The arrows show paths taken by the VFs as they flow through the TG. It can be seen that they appear from the left, and flow into the stacks either through three input channels as 12 or lower channel 14, vertical channel 16, and three input channels as 18.

After passing through the stacks and becoming pressurized (powering the device is described in the next section), the VFs enter horizontal channel 20 at the top of the figure, either directly, or via the three horizontal output channels as 22, and the vertical channel 24, or alternately via three output channels as 26, and vertical channel 28. They then exit the device to the left.

Six slanted partitions as 30, slanted vertical partition 32, and vertical partition 34 prevent the VF pressure from back-flowing to the input regions after emerging from the stacks. (Note that the stacks are one-way devices, and cannot themselves backflow).

The partitions also prevent the VFs emerging from a lower stack from passing into the one above—a matter that would reduce thrust generation efficiency, as is explained later.

The top, bottom, and rear covers 36, 38, & 40 further prevent VFs from leaking in or out of the system. It will be understood that there are also two side covers preventing any sideways leakage, both covers being in sealing contact with the full length of covers 36, 38, & 40. One cover faces the viewer, but cannot be shown since the view is cross-sectional, the other is at the rear of the drawing, but is omitted for clarity.

The various partitions and cover plates comprise jointly the first and second radiation guiding structures mentioned in the Claims.

The TG can also generate thrust if the VFs passing through the stacks flow straight through the device from left to right instead of entering from the left and reversing back upon themselves as shown. This can be arranged by removing right-hand cover-plate 40, and placing a partition similar to partition 34 at the left opening of topmost channel 20 to seal it off.

It will be apparent that the permanent direction of thrust can be reversed simply by rotating the device horizontally until the emission is to the right instead of to the left as shown in the drawing. To ensure balanced thrust during the transition, the thrust might be generated by an even number of identical TGs, half of which rotate clockwise, and the other half, anti-clockwise.

### The Terahertz Generator

For the purposes of example and calculation, the TGs are here described as being powered by rapid oscillation of external fields in the form of THz radiation. Lower frequencies will not be efficient, and higher infrared frequencies may produce heating problems. However, the generation of THz radiation is a comparatively new field, and although there are a number of somewhat standardized systems to choose from that have undergone significant development, non of them seem very satisfactory. These systems include gyrotrons; backward wave oscillators; far-infrared, quantum, and free-electron lasers; and synchrotrons [28].

Unfortunately, those that can develop significant power, such as gyrotrons, are inefficient and bulky, while others are currently limited to milliwatt outputs, and/or can only operate at 50K or worse. All emit only narrow beams.

Fortunately, two new choices have now been demonstrated. Both involve the development of nano-emitters formed into 2D matrices with huge packing densities, in rather similar fashion to the nanoantenna tiers 5 of FIGS. 1B & 1C, and can potentially produce square-meter beams from flat, pancake-like substrates, if required. The first uses superconducting Josephson junctions, and is able to generate THz radiation [29]. However, the temperature is limited to 50K, and despite the high packing densities, the output power density still appears to be low.

The second choice, developed at UCSD, involves micromachining nano-vacuum cold triodes and similarly forming high packing-density matrices. Emission power densities exceeding 100 W/cm² may be possible at room temperature. The frequency was limited to 10 Ghz in 2002[30]. However, a later paper [31] indicates that frequencies of 10 THz should be possible. We therefore select the UCSD system as our currently preferred THz emitter with which to power the TGs.

### Generating Rotary Motion

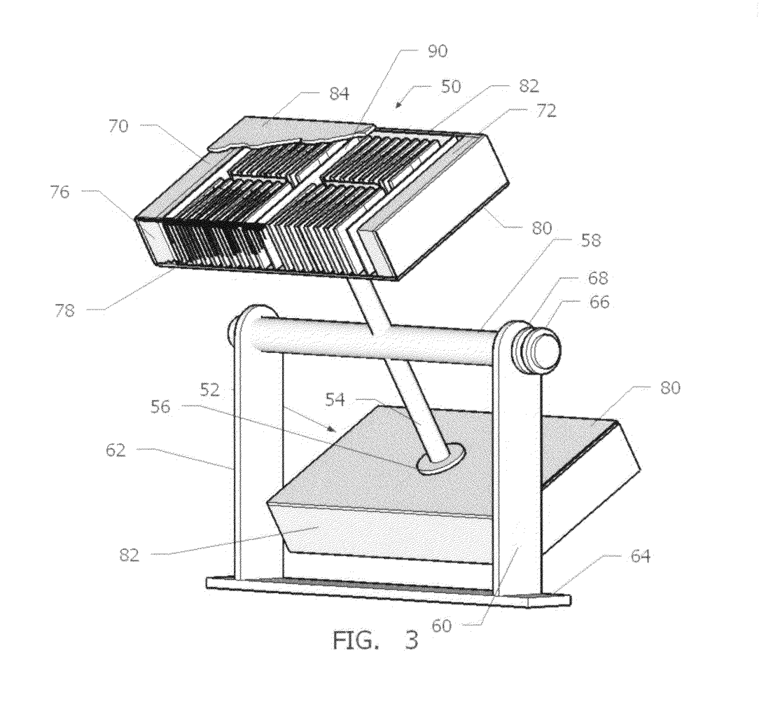

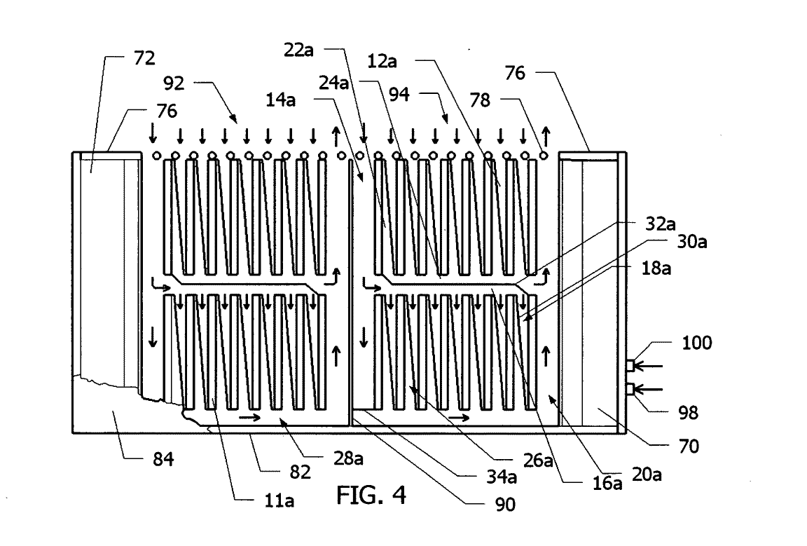

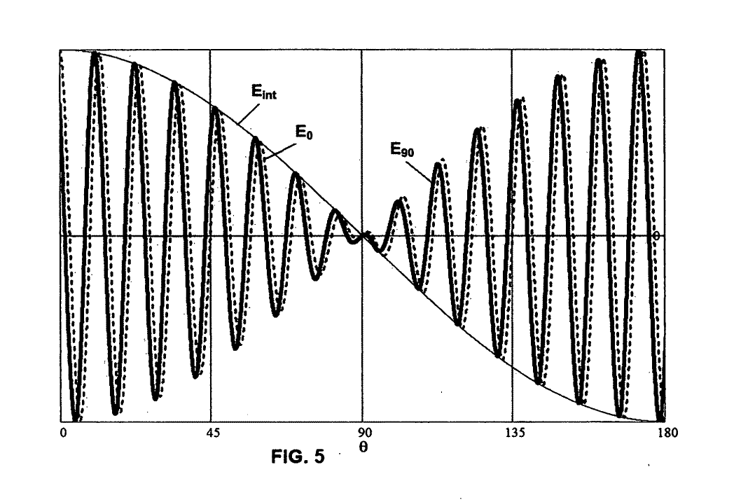

It will be apparent that if TGs are mounted on a rotatable shaft they will capable of generating rotary motion around the shaft. FIG. 3 shows a device configured for this purpose: The drawing shows TG assemblies 50 & 52, each of which contains two pairs of TGs separated by a central partition as 90. The TGs are geometrically tweaked but conceptually identical versions of that shown in FIG. 2. They can be seen more clearly in FIG. 4 which is described below. They are butt-joined to the end-faces of rod 54 via flanges as 56. Rod 54 is centrally secured to rotatable shaft 58, which is mounted on support arms 60 and 62, which are attached to base 64.

The two slip-rings 66 and 68 deliver electrical energy from a conventional power supply to a THz generator 70 similar to the UCSD device, via conventional brushes and supply-wiring that is not shown. The generator emits THz radiation directly into the TGs, causing them to amplify and unidirectionally emit VF radiation as previously described. The radiation is emitted tangentially to shaft 58, and thus urges the rotatably mounted TG assemblies 50 & 52 to rotate clockwise (top TG moving away from viewer) in the drawing.

The residual THz power that exits the TGs to the right in the drawing, passes into structure 72 which is so contrived as to either absorb the radiation and dissipate it as heat, or convert it back to electrical energy and return it to THz generator 70.

The VFs enter the TGs from free space through the exposed leftmost face of TG 50 in the drawing, and thus also through the unseen exposed rightmost face of TG 52. These faces are covered by mesh filters consisting of partially shown frames as 76 and wires as 78 which prevent the escape of THz radiation but freely transmits PHz radiation; it being the case that the mesh filters, in combination with partitions 80 (bottommost for TG assembly 50), partitions 82 (rearmost for TG assembly 50), and partitions 84 (topmost for TG assembly 50), function as a THz waveguide. From which it follows that the filters are so contrived as to present essentially the same reflective characteristics to the THz emissions as do the three partitions.

Suitable mesh filters can be supplied by Microtech Instruments located in Oregon, USA. If the output of THz generator 70 is polarized either S-wise or L-wise, it can be blocked by evenly spaced microwires with a diameter to spacing ratio of about three or four, having appropriate axial alignment to the THz beam. An unpolarized beam will require a mesh.

FIG. 4 shows the FIG. 3 TGs in top schematic view. Central partition 90 separates two identical TGs 92 & 94. The end cross-sections of mesh wires as 78 can be seen, as can the side sections of mesh frame 76. Two sockets 98 & 100 supply the generator with electrical energy from a conventional power supply, as indicated by the two arrows.

As stated, the TGs are conceptually identical to that shown in FIG. 2 with minor changes in dimensions. etc. Thus, numbering as in FIG. 2, there are 32 stacks as 11a, with diagonal partitions as 30a, and 32a, and partitions as 34a; the same arrangement of main channels as 14a, 16a, 20a, 24a, and 28a; and smaller channels as 12a and 22a.

### Buckyball Resonance

The nanoantennas described earlier may be tuned to have a natural resonance at a frequency of about 2 PHz (10¹⁵ Hz). This should be perfectly feasible since, for example, C60 buckyballs are known to have a giant resonance (with a surprisingly large bandwidth) at about 2 Phz [15]. Bertsch et al also predict “a giant collective resonance at an unusually high energy of ˜20 eV” (about 5 PHz), for C60 buckyball clusters [27]. It is also well known that fullerene resonances can be readily enhanced, or tweaked this way or that, by the insertion of additional elements in the form of one or two atoms [4, 24]. The very intense fields created by the THz generator can amplify these PHz oscillations in accordance with the ½αE² relationship described earlier, and thus increase the density of the VF PHz fields associated with the buckyballs, in sync with the field oscillations.

We assign the generator field intensity E_{gen} a peak value of 3E+5 V/m, this being the most likely level at which polarization saturation will occur in the nanoantennas, i.e, the point at which polarizability ceases to increase very much with increasing field strength. It might be thought that fields this high will cause electrical breakdown in the airgaps in the TGs. However, it has been found that micro and nano airgaps have a very high resistance to breakdown, this being because their short path lengths prevent ion-cascading. Also discharges are limited by work-function type effects [16, 17].

### Obtaining Constructive Interference

Antenna arrays emit unidirectionally because they are (typically) spaced a quarter-wavelength apart along their emission axes (the exact distance is usually tweaked for best results), and so driven that there is a time-lag of 90° between each successive antenna in that direction (i.e, they are driven in phase-quadrature), causing the antenna emissions to interfere constructively, and thus combine in the forward direction or direction of declining phase angle; while interfering destructively in the reverse direction, and very largely so to the sides.

This can best be seen in FIG. 5 in which Eᵢₙₜ, denoted by the thin solid line, is that part of the generator voltage E_{gen} which appears directly across the buckyballs which form the nanoantennas. Its amplitude is given by

$${E}_{int} := ( \frac{3 \cdot {ɛ}_{s}}{2 \cdot {ɛ}_{bb} + {ɛ}_{s}} ) \cdot {E}_{gen} ,$$

where ∈_{bb}=4 is the dielectric constant of the buckyballs, and ∈_{S}=4 is that of the stacks, for both the generator input frequency and the full VF bandwidth. It follows that

$$( \frac{3 \cdot {ɛ}_{s}}{2 \cdot {ɛ}_{bb} + {ɛ}_{s}} ) = 1 ,$$

in which case Eᵢₙₜ=E_{gen}=3E+5 V/m.

Also in FIG. 5, waveforms E₀ and E₉₀ show the nominal enhancement above zero-point level of the petahertz-frequency voltages induced in the nanoantennas by Eᵢₙₜ. E₀ is a waveform that is initially in phase with Eᵢₙₜ and is denoted by the thick solid line, where E₀=cos(θ)cos(θ·r), and r is the ratio of the generator stack VF wavelength λ_{ip.s} to the average VF stack wavelength λ_{av.s}, where λ_{ip.s}/λ_{av.s}=30.

E₉₀, denoted by the broken line, is a waveform that leads E₀ by 90 degrees due to the phase-quad spacing of the nanoantennas, and is thus given by E₉₀=cos(θ)cos(θ·r+π/4).

In accordance with the principle of pattern multiplication, E₀ and E₉₀ flow through any given stack in the form of travelling waves. They combine their amplitudes, the phase difference between them disappearing in the forward direction of flow. It can thus be seen that the stacks behave somewhat as do amplitude modulators, with Eᵢₙₜ simulating a carrier wave, while the induced VF waves behave analogously to signal waves.

For the purpose of example we set the tier-to-tier spacing between the antennas (center-to-center) at 0.8λ_{av.s}. This rather large spacing is necessitated by the fact that the center-to-center distance between two C3840 buckyballs placed in contact is about 0.65λ_{av.s}

When antennas are stacked this close together relative to their diameter, those skilled in the arts usually determine the exact distance of separation required to produce constructive interference in the forward direction by simple experimentation. It is likely that the best experimentally determined figure will not differ significantly from that assumed above [36].

Short gap lengths have the advantage that all antenna-antenna transitions take place within the reactive near-field distance in which—by definition—the transitioning particles remain in the virtual state [18, 19, 34]. The nominal reactive near-field distance of full-wave antennas is λ/2π, so the combined overlap distance of two such antennas=λ/π=0.318λ. We note that this is about twice the edge-to-edge gap length between the antennas, as developed above.

### Calculations

We set the maximum VF frequency v2 that we propose to transmit unidirectionally through the stacks at 10 PHz. This lies slightly above the ultraviolet transmission fade of lithium fluoride, which we consider to be a suitable dielectric for the stacks; but since the thickness of the stacks is only about 170 nm, the fade should not be a problem.

We assume a modest VF bandwidth=(v2−v1)/½(v2+v1)=0.2, where v1 is the minimum frequency and so equals 8.2 PHz. The average frequency vₐᵥ thus equals 9.1 PHz, corresponding to a free-space wavelength λ_{av.o}=33 nm. We have assumed that the permittivity of the stacks ∈_{S}=4, we further assume it is lossless, in which case the vₐᵥ wavelength in the stacks=λ_{av.s}=(λ_{av.o}/√∈ₛ)=16.5 nm. This figure provides the principle measuring stick for the stacks. We now set the generator frequency v_{g} at 3 THz, which therefore has a stack wavelength=λ_{ip.s}=(c/v_{g}√∈_{S})=500 nm.

Recalling that, as mentioned above, the average THz to PHz wavelength ratio=30, it is apparent that the phase difference between any two neighboring nanoantennas should best be considered only an average figure, and that a certain variance in individual phase measurements is to be expected for any given antenna pair.

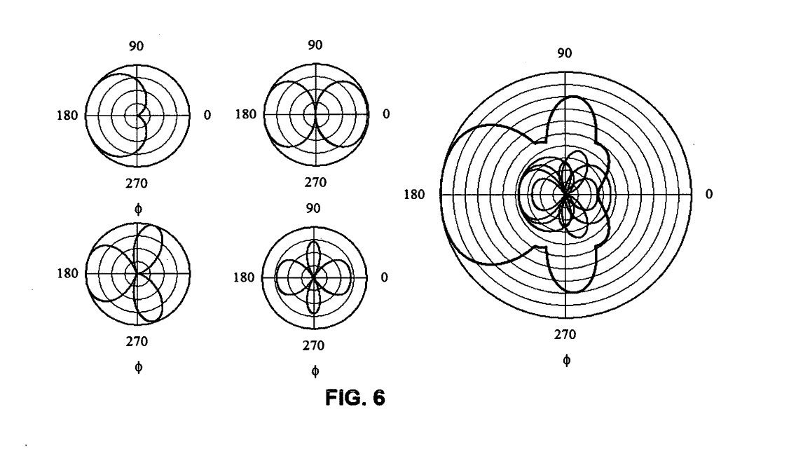

However, this is not a serious matter: FIG. 6 shows that unidirectional beam-forming of antenna pairs need not depend critically on the antenna phasing having any particular precise value. Here polar graphs labeled ¼, ½, ¾, & 1 show field amplitudes of two half-wave antennas separated by the same numbers of wavelengths, and driven respectively with phase difference of 90, 180, 270, and 360 degrees. These fields are combined additively in larger graph Σ, which shows the combined fields to be stronger to the left of the diagram than the right by a factor of about 2:1. It follows that reasonable variances in antenna phasing will not seriously affect the beaming efficiency of the TGs. Note that when large numbers of antennas are stacked together, as in the TGs, the rightward and side emissions shown in the above diagrams will be almost zero, since the diagrams are correct for only two antennas.

It should be particularly noted that the graphs—particularly graph Σ—indicate that if antennas are randomly spaced in a stack as FIG. 1D, they will still generate significant unidirectional emissions, as long as their maximum spacing is limited to about one wavelength.

This indicates that stacks suitable for use in TGs might be formed, by, for example, mixing buckyballs into a solvent into which a dielectric has been dissolved, and spraying the solution onto a substrate with an airbrush as described earlier, but this time using a buckyball concentration sufficient to produce an average spacing within the sprayed dielectric of about a half wavelength, once the solvent has evaporated. The amount of spray used should be sufficient to build a stack of whatever final thickness is desired, since it will not be formed by layering as before. The FIG. 1D stack, formed in this way, should emit radiation rather as shown in the FIG. 6 Σ combined-fields figure, excepting that, as stated, there will be no emission in the rearward direction, and very little to the sides.

We can now calculate the PHz emission rates: We have mentioned that when E₀ and E₉₀ flow through a stack in the form of travelling waves, they combine their amplitudes. It follows that since there are 26 nanoantennas in each stack, the nominal total forward flow=26 E₀ (or for that matter, =26 E₉₀). which, in either case, equals the peak value of Eᵢₙₜ.

We therefore define the average nominal energy flow along any single column of antennas in any given stack as

$${ɛ}_{an . av} = \frac{1}{2} {α}_{C 3840} \cdot 26 \cdot {( \frac{{E}_{int . pk}}{\sqrt{2}} )}_{17}^{216} = 2.2 E \text{-} 24 J ,$$

where E_{int.pk} is, of course, the peak value of Eᵢₙₜ. Losses will be dealt with later.

We assume that this virtual energy is emitted in the form of VFs. Therefore, to obtain the total nominal virtual energy output Eₛₜ per second of a one-square meter stack, and thus the total power of the emitted VFs, we multiply ∈_{an.av} by the number of antennas per tier=n_{a.tr}=1.47E+16, and the generator frequency v.ₐᵥ. Thus:

Eₛₜ=∈_{an.t}×n_{a.tr}×vₐᵥ=2.9E+8 Watt per stack per square meter.

This energy is virtual, and, of course, has no particular observable effects in and of itself. However, since it is the energy of the emitted VFs (½hv per fluctuation), we have only to divide by c to obtain the radiation pressure (hv/2c per fluctuation), which will have real effects as explained earlier. Thus:

pᵣₚ=Eₛₜ/c=0.98 newton per square-meter stack. We now divide by the constant of gravitation to get kilograms:

pᵣₚ/g=0.1 kg per square-meter stack, disregarding losses, which will be discussed in the next section.

If this figure seems high, we should bear in mind that it is produced by ˜10¹⁷ nanoantennas possessing giant polarizabilities, driven at near breakdown-limited field strengths, and operating at unprecedented THz frequencies.

Finally, we estimate the thrust output for a really large TG: And since, as already stated, the thickness of a 26 tier stack is only about 170 nm, we can readily pack about 10⁶ square-meter stacks one above another, to form a one-cubic meter TG. The thrust output of such a structure=pₘ₃=0.1×10⁶=10⁵ kg.

It is instructive to compare p_{kg} to the pressure p_{freeS} produced by free space VF densities acting on one side of a one square-meter mirror. It is determined by first calculating the energy density of free space E_{freeS} [22]:

$${E}_{FreeS} = [ \frac{{h}^{′}}{8 \cdot {π}^{2} \cdot {c}^{3}} \cdot ( {ω}_{2}^{4} - {ω}_{1}^{4} ) ] = 4.26 E + 5 J \text{/} {m}^{3} ,$$

from which the pressure, as described earlier:

$${F}_{FreeS} = ( \frac{1}{3} \cdot \frac{{E}_{FreeS}}{{g}_{m}} ) = 14490 kg \text{/} {m}^{2} ,$$

where ω2 & ω1 are v2 and v1 expressed in radians, h′=h/2π is the gravitational constant, and the 1/3 is an adjustment for isotropic distribution. This frequency range lies beyond the opacity region of many materials, but is, of course, fully balanced by the internal structural strengths of materials with higher frequency absorptions—the structural strengths being themselves due to internal VFs and other virtual photons.

We might note that the ratio of stack radiation pressure pᵢₚ to p_{freeS} is only about (7×10⁻⁶):1. This means that the stacks shown in FIGS. 2, 3, & 4 will need only proportionately narrow channels (as 12, 22, & 14, 20, 28, 24, 16; FIG. 2 and their FIG. 4 counterparts), set between them to provide for VF flow.

### Losses

We identify the principle losses and their associated decimal multiplier as follows:

1. Imperfect transparency of the dielectric in the stacks: ≅×0.75.
2. Unwanted VF scattering in the stacks and losses due to imperfect antenna positioning: ≅×(1/3).
3. Reduction in effective radiation pressure due to beam spread to either side of normal: ≅[1−cos(30)]=×0.846.
4. Lack of proportionality between increase of nanoantenna VF potential energy with E.ᵢₙₜ² due to polarization saturation: ≅×(2/3).
5. Finally we estimate inefficiencies in the transmission of VFs from antenna to antenna in the tiers, by making a reasonable assumption that the antennas transmit their outputs one to another in the forward direction with a decimal efficiency η=0.95. The output of the first antenna will then=η¹=0.95, the combined output of the first and second will=(η¹+η²)=1.853, and so on. This can be solved for any number of tiers by the summand below, which shows the gain gₙ for any number of tiers nₜₛ per stack. An assumption that nₜₛ=26 looks good, in which case:

$${g}_{n} = {[ {\sum }_{{n}_{t . s} = ( {n}_{t . s} )}^{0} {η}^{{n}_{t . s}} ]}_{= 14} .$$

We therefore add a loss factor ≅×(14/26).

6. Finally we add ×0.7 for miscellaneous losses.

The summed losses therefore

≅(0.75×(1/3)×0.846×(2/3)×(14/26)×0.7)=0.053.

Adjusting by this factor, we find that the net pressure per stack

=p_{rp.net}=0.1×0.053=0.0053 kg/m²,

and similarly, the net pressure developed by a cubic meter TG=5300 kg.

### Closing Remarks

It is to be understood that the calculations presented here are only intended as a rough guide to the performance of the apparatus. And further, that even though numerous characteristics and advantages of the present invention have been set forth in the above description, together with details of the structure and function of the invention, the disclosure is illustrative only, and changes may be made in detail, especially in matters of shape, size and arrangement of parts within the principles of the invention, to the full extent indicated by the broad general meaning of the terms in which the appended claims are expressed.

Further, the theories given above as to why VFs may usefully exchange momentum with propulsive devices, are provided in the spirit of presenting information as best the inventor is able, but it should be understood that the operation of the devices described here do not necessarily depend on the theories being correct as stated.

What is claimed is:

1. A method for producing thrust in a mass without ejection of tangible propellant, said method comprising the following steps;
a) absorbing from free space the virtual radiation of so-called virtual particles such as vacuum fluctuations by means of antenna-like structures;
b) causing said virtual radiation to flow along a plurality of said antenna-like structures whilst its field intensities are caused to be amplified;
c) causing said virtual radiation with said amplified field intensities to be returned to free-space or emitted by said antenna-like structures;
d) said emitting of said virtual radiation being further caused to occur in an essentially unidirectional or beam-like pattern;
e) it being well known to those versed in the arts that said virtual radiation generates real radiation pressure, it is thus the case that said unidirectional emission of said virtual radiation causes said radiation pressure to urge said mass to move in accordance with Newton's third law, whereby the force exerted on said mass by said radiation pressure, and the reverse, are simultaneous; equal in magnitude; opposite in direction; and in the same line;
f) steps (a) through (d) are accomplished by causing said antenna-like structures to be:
(1) appropriately structured such that they are tuned and suitably resonant in the targeted frequency range of said virtual radiation;
(2) appropriately spaced apart or contiguous, such that they are suitably linked one to another with regard to efficiency of radiative transfer, and so as to cause such particular electromagnetic phase differences between neighboring said antenna-like structures as may be required;
(3) appropriately energized by rapidly oscillating externally generated electromagnetic fields, such that said rapid oscillations of external fields cause said field intensities of said virtual radiation to vary cyclically.

2. The method recited in claim 1 wherein the following means are provided;
a) first means for converting to travelling waves, the standing waves, otherwise known as oscillations, of said virtual particles, that are known to exist resonantly in numerous forms of matter;
b) second means to provide that said numerous forms of matter take the form of nanoparticles, examples of which are fullerenes, nanotubes, spherical nano-clusters, and the like; along which said travelling waves may flow, growing in strength due to said amplification of field intensities as they do so, in approximate proportion to the number of said nanoparticles;
c) third means whereby said travelling waves, on reaching an end-point of said nanoparticles, here termed the emitting end, are caused to undergo said emission into free space;
d) it being the case that said flow of said travelling waves, and their said emission from said emitting end of said nanoparticles, causes said field intensities to become depleted to below zero-point level at or near another end-point, here termed the receiving end, at or near which said flow begins;
e) it being further the case that said absorbing of said virtual radiation from free space occurs at or near said receiving end, thereby combining with, and contributing additively to, said flow of said travelling waves to said emitting end of said nanoparticles; thus restoring said depletion below zero-point level of said virtual radiation, and increasing it to above zero-point level;
f) it being understood that while said depletion and said increasing of said virtual radiation is described in cause and effect terms for clarity, they are essentially simultaneous;
g) it therefore being the case that said absorption; said flow of said travelling waves to said emitting end; and resultant said emission, may continue for as long as suitable apparatus for accomplishing the several means of this claim is appropriately energized.

3. Apparatus for accomplishing the goals of claim 2, comprising:
a) said nanoparticles such as may possess large electrical polarizabilities, particularly those formed from one of the general classes of materials possessing so-called giant polarizabilities; two such examples being various fullerenes and Na₁₄F₁₃ molecules;
b) whereby said nanoparticles are so formed and positioned in said apparatus, as to function operatively as nanoantennas, such as may be best suited for said absorbing, said amplifying, and said emission of said virtual radiation;
c) by said nanoantennas, is meant electromagnetic antennas, of comparable size to the wavelengths of said virtual radiation, said wavelengths being sub-micrometer in length; it being understood that said nanoantennas may also be linked contiguously one to another to form what is known to those versed in the arts as long-wire antennas;
d) first means of assembling said nanoantennas into 2D arrays, by which is meant a single layer of said nanoantennas, multiple in number, that are formed into rows and columns in a single plane;
e) second means of assembling said 2D arrays by a stacking process to form 3D arrays; the spacing between said nanoantennas in said 2D and said 3D arrays being such as may best permit said nanoantennas to accomplish said absorption, said amplification, and said unidirectional emission, of said virtual radiation, when energized by said rapid oscillations of external fields;
f) to better illustrate, we mention that one well known example of said spacing of antennas in beaming arrays is that which permits said antennas to operate in phase-quadrature.

4. means of assembling said 3D arrays of claim 3 in a modified format, said modification being that said nanoantennas placed within it are spaced apart somewhat randomly instead of being arranged in a regular order as disclosed in 3(d) and 3(e); it being the case that the construction of said modified 3D array may thus be simplified;
a) it being further noted that the maximum spacing between said nanoantennas in said modified 3D arrays should be of the order of a wavelength of said virtual radiation.

5. Means whereby said 3D arrays of claims 3 may be placed one above another, or otherwise in close proximity to each other, while being separated by first radiation guiding structures, such that said emissions of one said 3D array is prevented from becoming the input of another; this being undesirable because such series feeding may lower the efficiency of said emission of said virtual radiation.

6. Means whereby said 3D arrays of claims 3 are housed within second radiation guiding structures that may be minor additions to said first radiation guiding structures, and which so direct said virtual radiation entering said first and second guiding structures, that said virtual radiation is emitted in the direction from which it first entered;
a) that is to say, that if, by way of example, said virtual radiation enters said first and said second guiding structures from the left, it also exits to the left, thus being scattered back about 180 degrees; thereby approximately doubling said radiation pressure acting on said first and said second guiding structures;

7. Apparatus for generating said rapid oscillations of external fields of claim 3, for the purpose of energizing said 2D and said 3D arrays, whereby said rapid oscillations of external fields cause said amplification of said field intensities of said virtual radiation in said nanoantennas;
a) said apparatus for generating said rapid oscillations of external fields consisting of a high-packing density matrix of nano-emitters such as nano-vacuum cold triodes or the like, able to emit beamed electromagnetic radiation at terahertz frequencies or greater; said beams being capable of covering large areas of a square-meter or more when required for such applications as thrusting heavy vehicles;
b) means for developing electrical phase differences in said oscillations of said virtual radiation in said 2D and said 3D arrays, whereby said emissions of neighboring said nanoantennas interfere constructively in a preferred direction, and interfere destructively, or nearly so, in all other directions.

8. Means whereby said apparatus of claim 7 for generating said rapid oscillations of external fields may operate at a frequency lower than the frequency of said oscillations of said nanoantennas, while non-the-less causing said emissions of said nanoantennas at a higher frequency;
a) for example, said apparatus for generating said rapid oscillations of external fields may operate in the terahertz, i.e, 10¹⁴ hertz frequency range, while causing changes in the amplitude of said oscillations of said virtual radiation of said nanoantennas in the petahertz, i.e, 10¹⁵ hertz range, thereby producing said emissions at said petahertz range.

9. Means whereby said 3D arrays of claim 3 are rotatably mounted on pivoting means such as a shaft seated on bearings, such that said virtual radiation emitted by said 3D arrays is tangentially directed around said pivoting means, whereby it urges rotation of said 3D arrays around said pivoting means;
a) it being the case that said rotation may convey rotational energy to conventional work-performing devices, by means of gear trains or the like;
b) it being further the case that apparatus for causing said rapid oscillations of external fields may likewise be rotatably mounted on said pivoting means, so as to be in suitable close proximity to said 3D arrays;
c) wherein said apparatus for generating said rapid oscillations of external fields may be energized by conventional power supplies; said power being transmitted by such means as brushes and slip-rings mounted on said pivoting means; inductive transfer of power from a stationary coil to a rotating one mounted on said pivoting means; electrodes immersed in mercury pools, and the like.
